(19) United States
(12) Patent Application Publication
(10) Pub. No.: US 2014/0051910 A1
(43) Pub. Date: Feb. 20, 2014

(54) Transport Incubator System Frame with Tank Trays

(71) Applicant: DRAEGER MEDICAL SYSTEMS, INC., Telford, PA (US)

(72) Inventors: Christina Ann Arnold, Perkasie, PA (US); David D. Rogers, Quakertown, PA (US); Kerry Guarino, Philadelphia, PA (US); Scott Gordon Klos, Grafton, WI (US); Michael J. Kahn, Cedarburg, WI (US)

(73) Assignee: DRAEGER MEDICAL SYSTEMS, INC., Telford, PA (US)

(21) Appl. No.: 13/713,955

(22) Filed: Dec. 13, 2012

Related U.S. Application Data
(63) Continuation of application No. PCT/US2012/054287, filed on Sep. 7, 2012.
(60) Provisional application No. 61/683,618, filed on Aug. 15, 2012.

(51) Int. Cl. A61G 11/00

(52) U.S. Cl. CPC A61G 11/00
USPC 600/22

(57) ABSTRACT

A transport incubator system includes an incubator, a system frame, and, optionally, supporting components. Supporting components can include a dampening system, slide-out internal compressed gas cylinder storage trays, a monitor mount, handles, strapping points, a chart and hand-held device holder, an electrical control box, a pneumatic control box, an accessory deck, an LED examination light, and a DC distribution component. Methods of using such a transport incubator system are also described.

### CROSS REFERENCE TO RELATED APPLICATIONS

This application is a continuation of PCT Patent Application Serial Number PCT/US2012/054287, titled “Transport Incubator System,” filed Sep. 7, 2012, which in turn, claims priority to U.S. Patent Application Ser. No. 61/683618, titled, “Transport Incubator System,” filed Aug. 15, 2012; the contents of each of the foregoing applications are hereby fully incorporated by reference.

### TECHNICAL FIELD

The subject matter described herein relates generally to the field of medical devices, and more particularly to devices, systems, articles, and methods used to transport infants or neonatal patients while in an incubator.

### BACKGROUND

Transport incubators help infant and neonatal patients maintain a controlled environment with low risk of infection, as well as a constant body temperature, proper blood oxygen content, and moisture levels in exposed tissues, such as skin. Transport incubators must accomplish at least these tasks while operating on mobile power and compressed gas sources. Additionally, transport incubators are required to fit into diverse types of vehicles and to carry their patients through rough, and at times noisy, conditions without causing excessive stress to the patients.

### SUMMARY

Provided herein is a transport incubator system that includes an incubator, a system frame, and, optionally, supporting components. Methods of using such a transport incubator system are also described.

In one aspect, a transport system includes an incubator and a system frame that is configured to couple and decouple from the bottom portion of the incubator.

In an interrelated aspect, the transport system includes an incubator, a system frame, and a dampening system that is disposed between the top of the system frame and the bottom of the incubator when the incubator is coupled to the frame. The dampening system includes two or more dampers of deformable material, each damper having a cylindrical or a prism shape and an axis that passes through the center of each shape. In the dampening system, at least two of the dampers are positioned so that their corresponding axes are orthogonal to each other.

In a transport system with an incubator, a system frame, and a dampening system, the dampers in the dampening system can be hollow. Additionally, the dampers can have a prism shape that can include a triangular, an elliptical, a square, or a rectangular cross-section. The dampening system can also include at least one mounting element that is configured to secure to the incubator and at least one mounting element that is configured to secure to the system frame. Further, the dampening system can include a tether that restricts movement of the incubator relative to the system frame. The dampening system can include four sets of at least two dampers, in which each set corresponds to a respective corner of the bottom of the incubator.

In another interrelated aspect, the transport system with an incubator and a system frame can also include one or more slide-out internal compressed gas cylinder storage trays that are attached to the system frame. The one or more slide-out internal compressed gas cylinder storage trays can be beneath the incubator. The one or more slide-out internal compressed gas cylinder storage trays can also include a tray handle and an actuating, locking handle. Each of the one or more slide-out internal compressed gas cylinder storage trays can have a latch that is released with movement of the actuating, locking handle, in which releasing the latch allows each tray to slide out. Also, each of the one or more slide-out internal compressed gas cylinder storage trays can have straps for securing a compressed gas cylinder. Each of the one or more slide-out internal compressed gas cylinder storage strays can be lined with a high-friction material and a material with a low coefficient of friction. In such systems where each of the one or more slide-out internal compressed gas cylinder storage strays can be lined with a high-friction material and a material with a low coefficient of friction, the high-friction material can be located along the portion of each tray under the straps, near the tray handle. Additionally, in such systems, the low friction material can cover a portion of each tray that is furthest away from the tray handle and enables a user to slide a gas cylinder easily into place. Each of the one or more slide-out internal compressed gas cylinder storage trays can also sit on rails of low weight, high strength, and low friction material. In such systems, the rails can include polyacetal polymers. Additionally, each one of the one or more slide-out internal compressed gas cylinder storage trays can include a plurality of holes. The plurality of holes can be configured to accept straps at different locations to accommodate different sized cylinders. The plurality of holes can also serve to lighten the weight of each tray. Alternatively, in a system with one or more slide-out internal compressed gas cylinder storage trays, each tray can have a plurality of holes that are configured to both accommodate straps for different sized cylinders and to lighten the weight of each tray. The one or more slide-out internal compressed gas cylinder storage trays can include a light-weight and strong metal alloy, a high strength to weight ratio polymer composite, or a ceramic material.

In a further interrelated aspect, the system that includes an incubator and a system frame can also include a monitor mount that is connected to the system frame. The monitor mount can be configured to fit above a ventilator located on the top portion of the system frame, adjacent to the incubator. The monitor mount can include a bar and a grid of fitting holes that accommodate a position of the bar required to fit a portable patient monitor. The system can also include a portable patient monitor.

Another interrelated aspect pertains to four or more handles that can also be part of the system, operably connected to the system frame and configured to facilitate moving the system to, from, into, and out of a type of transportation. The four or more handles can have at least two positions. A first position can be a position used to carry the system, and a second position can be a non-carry position. The four or more handles can also include a third position that is an alternate position used to carry the system. Each of the four or more handles can include a first end and a second end. The first end of each handle can include a connection point with a hole through which a fitting on the system frame passes. Each handle can also include a locking pin that fits into one or more recesses on the system frame. In such systems, the locking pin can be biased into a position where the locking pin is inserted into the one or more recesses on the system frame, and each handle can include a release mechanism that, when actuated, pulls the locking pin out of the one or more recesses.

An interrelated aspect can also include one or more strapping points fixed onto the system frame. The one or more strapping points can allow for temporary or reinforcing connections between the system and a sled or trolley. Each of the one or more strapping points can attach onto the system frame through a fixture point. Additionally, each fixture point can be located on the system frame in an area that avoids blocking any instrumentation panels when a strap is fitted through the strapping point and fixture point. Each fixture point can also be located on the system frame in an area that keeps clear of joints and instrumentation on both the sleds or trolleys and the system.

In a further interrelated aspect, the system can include a chart and hand-held device holding compartment affixed to one end of the system frame. The chart and hand-held device holding compartment can be configured to secure a chart and a hand-held device. The chart and hand-held device holding compartment can include a larger pocket that is configured to hold a patient chart and a smaller pocket that is configured to hold a hand-held device. The larger pocket and the smaller pocket can each have covers that include loop-and-hook closures to keep the covers in place. The cover of the smaller pocket, as well as the smaller pocket itself, can include a mesh material that allows the hand-held device to be seen while in transit.

In another interrelated aspect, the system can further include an electrical control box mounted on the system frame. The electrical control box can be beneath the incubator in the system. Also, the electrical control box can include a physical barrier sufficient to prevent oxygen from accumulating above a concerning level. The electrical control box can include an alarm that indicates when a level of oxygen within the electrical control box reaches a concerning level. Additionally, the concerning level of oxygen within the electrical control box can be 25% or greater oxygen enriched.

A related interrelated aspect can also include a pneumatic control box mounted on the system frame. The pneumatic control box can be beneath the incubator. The pneumatic control box can also include a physical barrier that is sufficient to prevent a hazardous collection of a flammable gas outside the pneumatic control box. Further, the pneumatic control box can include regulators for compressed gases feeding into the incubator. In such systems, the pneumatic control box can also include one or more regulator mounts with end blocks. The pneumatic control box can also include pressure transducers. The pneumatic control box can be configured to accept gas from a wall source of gas or from one or more gas cylinders. Also, the pneumatic control box can be configured to form the lid or cover of another control box.

Further, in an interrelated aspect, the system that includes an incubator and a system frame can also include an accessory deck located on the system frame adjacent to the incubator. The accessory deck can have at least one T-slot rail mounted on the deck that is configured to receive at least one accessory device. The system can include a ventilator connection plate that is mounted on the accessory deck and operably connected to a ventilator. An accessory pole mounted on the accessory deck can also be a part of the system. The system can also include a clip mounting for a suction collector that is mounted on the accessory deck. In such systems, the clip mounting for a suction collector can include a mounting site for an exhalation valve.

An interrelated aspect can include a detachable examination light that is operably mounted on the incubator of the system. The examination light can include light emitting diodes (LEDs).

In a further interrelated aspect, a direct current (DC) distribution component can also be a part of the system. The DC distribution component can include direct current components and one or more DIN rails. End brackets can also be a part of the DC distribution component. The DC distribution component can also include one or more of a fuse holder, a 6 volt DV (VDC) relay, one or more two-level terminal blocks which are switched v. battery bus, a DC to DC converter, and one or more two-level terminal blocks that are a DC to DC output bus. Additionally, the DC distribution component can be configured to shut down the transport incubator system completely without accidentally leaving a battery draining component switched on.

In an interrelated aspect, a dampening system can include two or more dampers of deformable material that are configured to be disposed between a top portion of a system frame of a transport incubator system and a bottom portion of an incubator when the incubator is coupled to the system frame. In such a system, each damper can have a cylindrical or a prism shape and an axis that passes through the center of each shape, and at least two of the dampers can be positioned so that their corresponding axes are orthogonal to each other.

The features of the system aside from the incubator and the system frame are optional and can be present in the system in any suitable combination.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a transport incubator system;

FIG. 2 illustrates a view of a frame of the transport incubator system as shown in FIG. 1;

FIG. 3 illustrates a view of the frame of the transport incubator system with the handles in stowed, or not active, positions;

FIG. 4a illustrates a view of a handle;

FIG. 4b illustrates an exploded view of a handle;

FIG. 5 illustrates a view of the frame of the transport incubator system in which the slide-out internal gas storage trays can be seen;

FIG. 6 illustrates a slide-out internal gas storage tray with locking handle;

FIG. 7 illustrates a transport incubator with some additional components;

FIG. 8 illustrates an examination light;

FIG. 9 illustrates an examination light showing the side opposed to the view seen in FIG. 8;

FIG. 10 illustrates a view of the frame of the transport incubator system with a ventilator, a monitor mount, pneumatic and electrical control boxes, and a ventilator connection plate;

FIG. 11 illustrates a monitor mount;

FIG. 12 illustrates a view of the frame of the transport incubator system with a ventilator, a monitor mount, and gas and electrical control boxes;

FIG. 13 illustrates an electrical control box;

FIG. 14a illustrates a pneumatic control box;

FIG. 14b illustrates a pneumatic control box as seen with a transparent housing;

FIG. 15 illustrates an accessory deck portion of a transport incubator system frame;

FIG. 16 illustrates a ventilator connection plate;

FIG. 17 illustrates an alternate view of the ventilator connection plate of FIG. 16;

FIG. 18a illustrates a clip mounting for a suction collector;

FIG. 18b illustrates a clip mounting for a suction collector attached to an accessory deck;

FIG. 19a illustrates an alternate view of a clip mounting for a suction collector wherein the fitting that allows for mounting of an exhalation valve can be seen;

FIG. 19b illustrates a clip mounting for a suction collector with an exhalation valve attached;

FIG. 20 illustrates an accessory pole which can be mounted on an accessory deck;

FIG. 21 illustrates a regulator mount which can be found inside the pneumatic control box;

FIG. 22 illustrates a DC power distribution component;

FIG. 23 illustrates a strapping point that can attach a transport incubator system to a sled or trolley;

FIG. 24 illustrates a wheel assembly for a transport incubator system;

FIG. 25 illustrates a dampening system for a transport incubator system;

FIG. 26 illustrates a patient chart and hand-held device holding compartment for use with a transport incubator system; and

FIG. 27 illustrates a transport incubator system configuration in which flow regulators are mounted on the gas cylinders, as opposed to in a pneumatic control box.

Like reference symbols in the various drawings indicate like elements.

### DETAILED DESCRIPTION

Disclosed herein are transport incubator systems that can be used to transport infant and neonatal patients in various conditions while attending to their medical needs. The transport incubator systems described herein can optimize power requirements to allow for the longest period of care using vehicle power or battery power, as well as optimizing strength to weight characteristics and space requirements so that the systems can fit easily into various types of transportation, without requiring excessive resources. A care provider, such as a doctor or nurse, can find that the transport incubator systems described herein provide easier access to device and medical connectors and controls needed to provide optimal care for infant and neonatal patients while in transit.

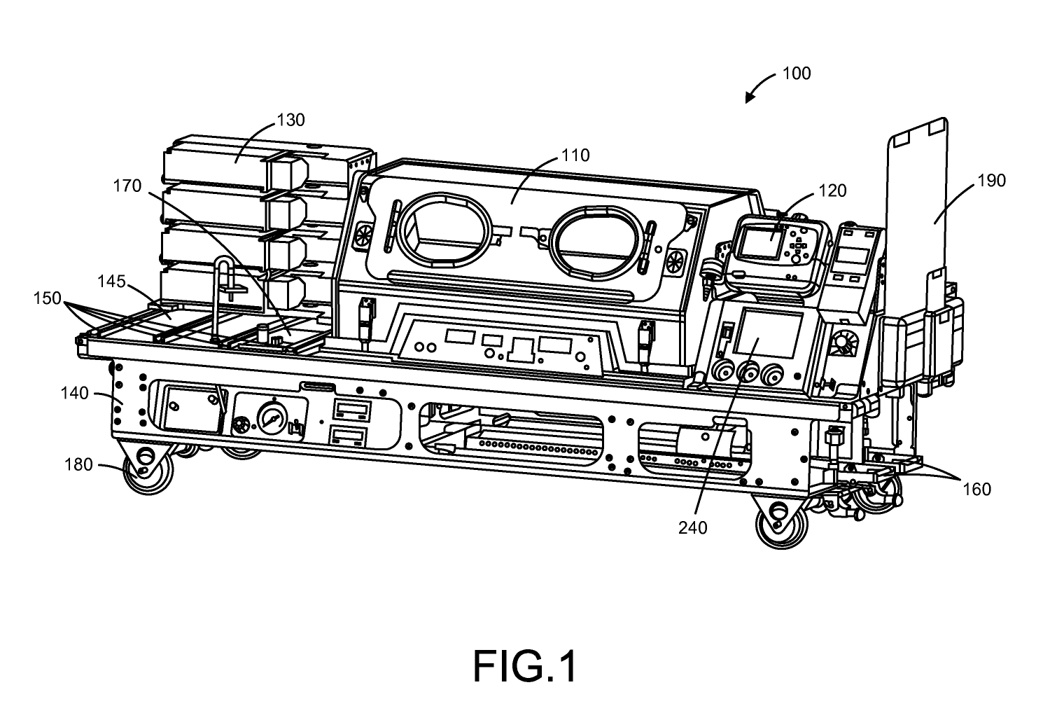

FIG. 1 shows an infant and neonatal transport incubator system 100 that includes an incubator 110 that sits on a frame 140. The frame 140 includes an accessory deck 145 to one side of the incubator 110. The accessory deck 145 includes T-slot extruded metal rails 150 that can be used to attach items such as infusion pumps 130, a ventilator connection plate 170, and the like near the head-end of the incubator 110. The frame 140 also includes one or more slide-out internal compressed gas cylinder storage trays 160. The transport incubator system 100 also includes a removable patient monitor 120, and/or front mounted controls; a patient chart and hand-held device holding compartment 190; and handles 200 for moving the system. A ventilator 240 is a part of the transport incubator system 100. Other accessories and components can be part of the transport incubator system 100 as needed for the health and safety of the patient. Conversely, a transport incubator system 100 need not include all of the components listed here.

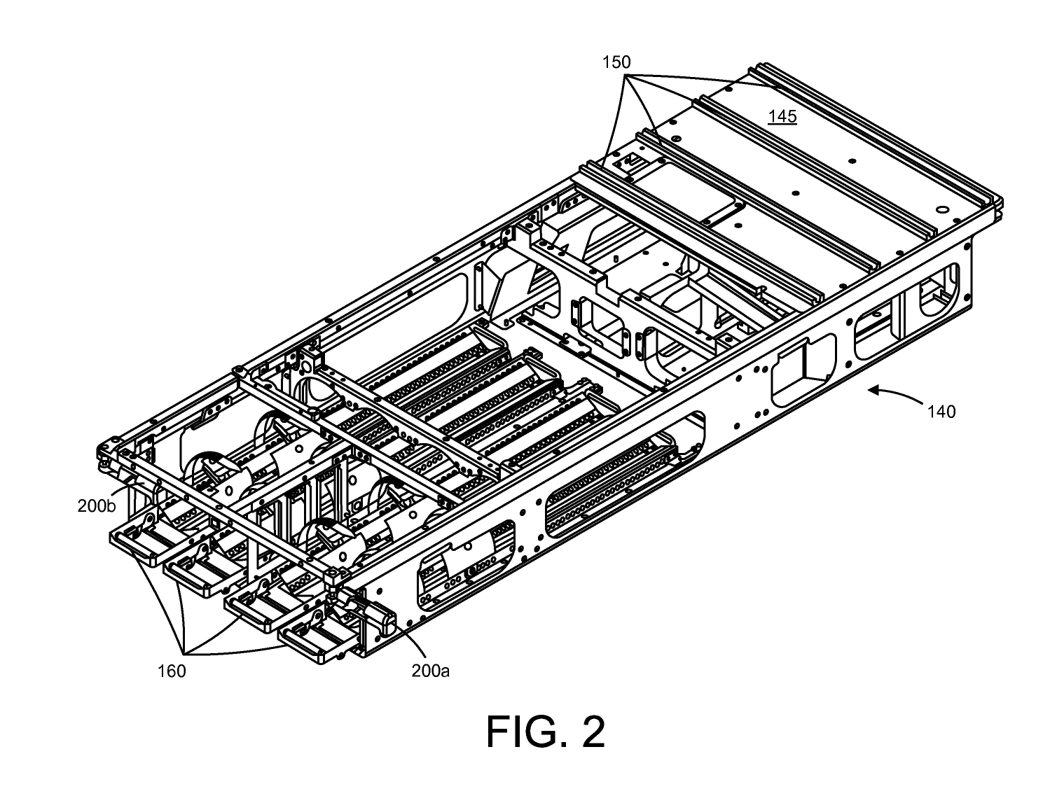

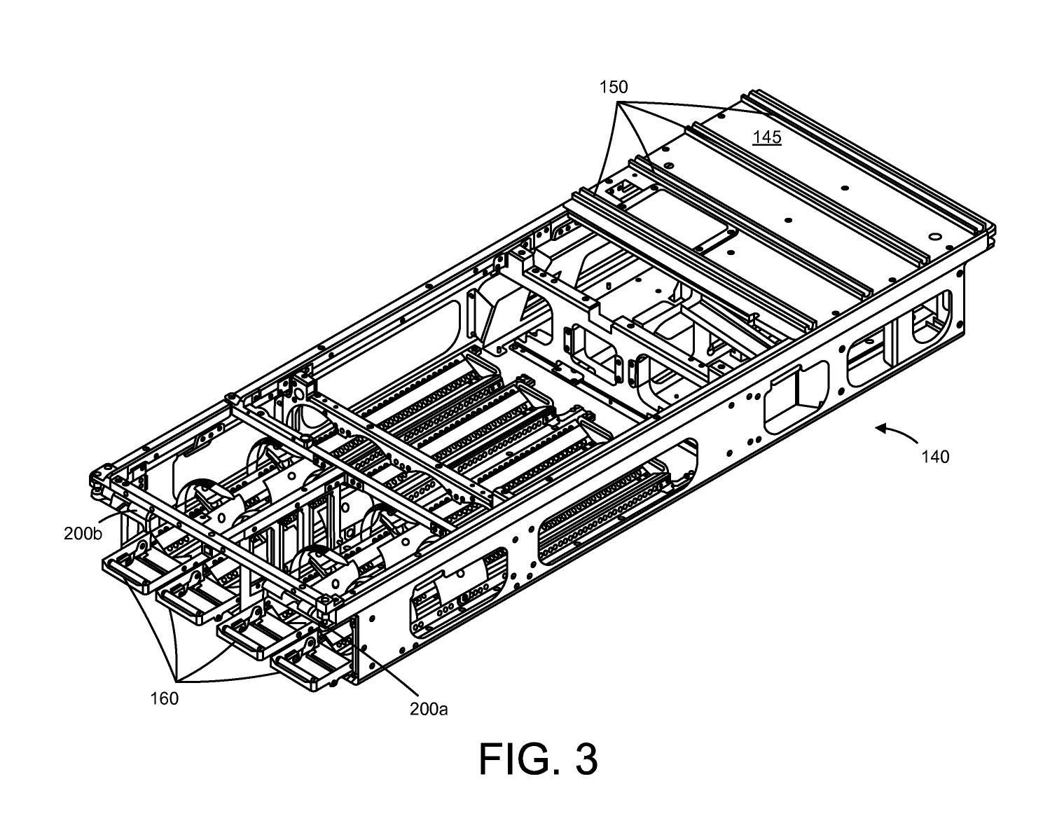

FIG. 2 illustrates a view of the frame 140 of the transport incubator system 100 without the incubator or wheels. The accessory deck 145 is shown with four T-slot rails 150 on one end of the frame 140. The number and configuration of the T-slot rails 150 can vary to suit the types of accessories to be used on the accessory deck 145. On the opposed end of the frame 140 are four slide-out internal compressed gas cylinder storage trays 160. Above the slide-out compressed gas cylinder storage trays 160 are handles, 200a and 200b. Handle 200a is shown in one of three positions, this position is one used to carry the system 100. Handle 200b is shown in another position, a storage, or non-carry, position. FIG. 3 illustrates the frame 140 of the transport incubator system 100, but in this view, both of the visible handles 200a and 200b are in storage, or non-carry, positions. In total, a transport incubator system frame 140 can have at least four handles, one on each corner of the frame 140.

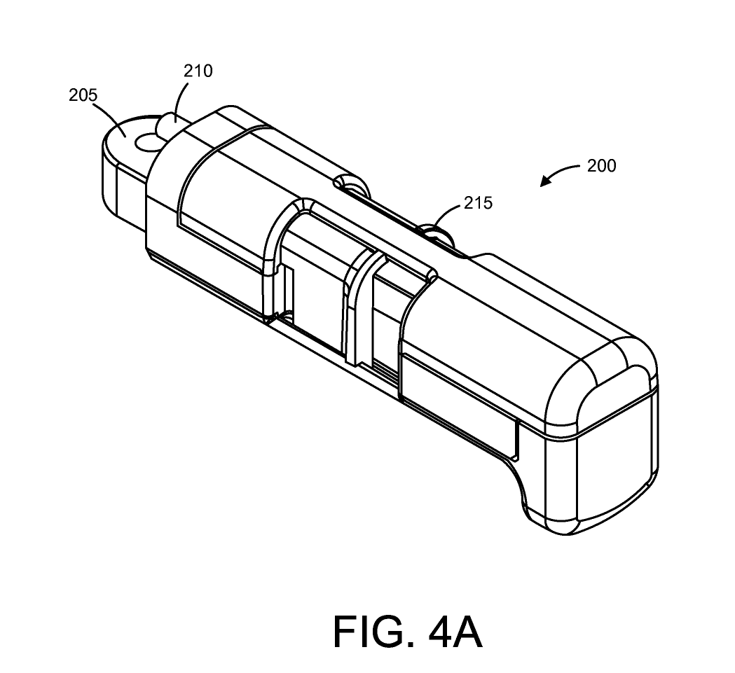

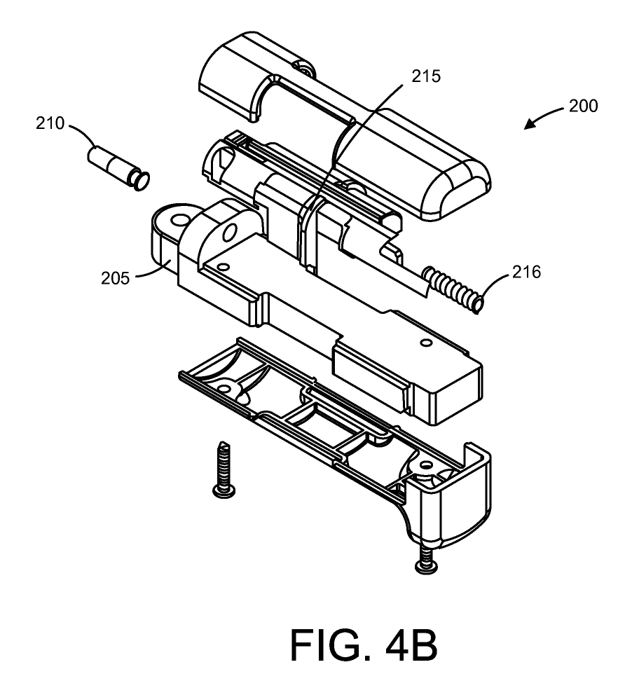

FIGS. 4a and 4b illustrate the handle 200 that is attached to the frame 140 of the transport incubator system 100. At a first end, the handle 200 has a connection point 205 with a hole through which a fitting on the frame 140 passes. The handle 200 can rotate about this point 205. A projection, or locking pin, 210 can fit into one or more recesses on the frame 140 that are located along the path which the handle 200 rotates. The recesses can be located in regular intervals, such as about 90 degrees apart, about 60 degrees apart, about 45 degrees apart, or about 30 degrees apart. The locking pin 210 can be biased by a spring or other mechanism into a position where it is inserted into a recess on the frame 140, if properly aligned. Each handle 200 can have a release mechanism 215 that can be actuated by a user's thumb or other fingers to pull the locking pin 210 out of a recess in the frame 140. FIG. 4b is an exploded view of the handle shown in FIG. 4a and shows a spring 216 that can bias the locking pin 210 in the engaged position.

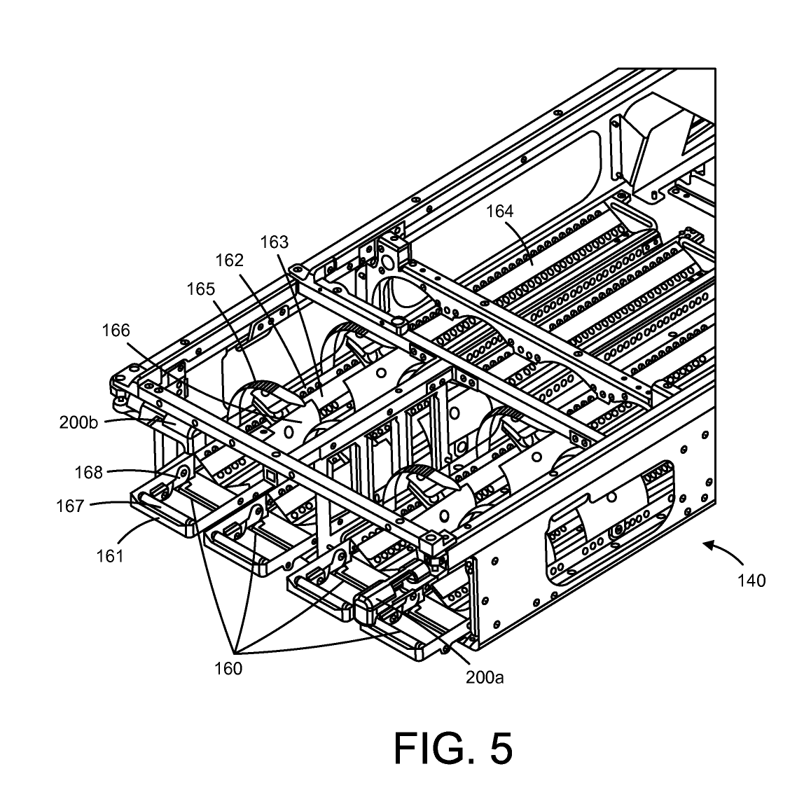

The transport incubator system 100 frame 140 is shown in FIG. 5 with one handle 200a in a use position for carrying the system 100 and the other handle 200b in a non-carry position. The slide-out internal compressed gas cylinder storage trays 160 are also shown. Each of the slide-out internal compressed gas cylinder storage trays 160 has a tray handle 161 and an actuating, locking handle 167. A pivot point and latch 168 are connected to each actuating handle 167. The latches 168 enable each slide-out internal compressed gas cylinder storage tray 160 to remain within the body of the system frame 140 during transport. However, in preparation for transport or after a journey, compressed gas cylinders can be inserted or removed from the trays 160, and the trays 160 will need to be more accessible. To slide each tray 160 out, a user pushes down on the actuation handle 167, and the latch 168 comes free. The portion of the tray on which a gas cylinder is placed 162 has straps 165 at one end for securing a compressed gas cylinder. The straps 165 in FIG. 5 are ratcheting straps, wherein the strap 165 advances a fixed amount through the buckle with each tightening movement. The length of the strap 165 that is not actively encircling a compressed gas cylinder is held in place by loop-and-hook fastening material, such as Velcro®, 166.

The length of a tray 160 is shown in FIG. 5 as lined with a high-friction material 163, and a material with a low coefficient of friction 164. The low friction material 164 covers the portion of the tray 162 furthest away from the handle 167. The location of the low friction material 164 enables a user to slide a gas cylinder easily into place. The high friction material 163 is located along the portion of the tray 162 that is under the straps 165, near the tray handle 167. The high friction material 163 helps to keep a gas cylinder in place while the system is in transit.

The slide-out internal compressed gas cylinder storage trays 160 can accommodate cylinders of compressed gas ranging in diameter from 3.5 inches to 4.72 inches and ranging in length from 17 inches to 34 inches. Such sizes encompass medical grade E size cylinders in the United States and 2 to 3 liter cylinders in Europe.

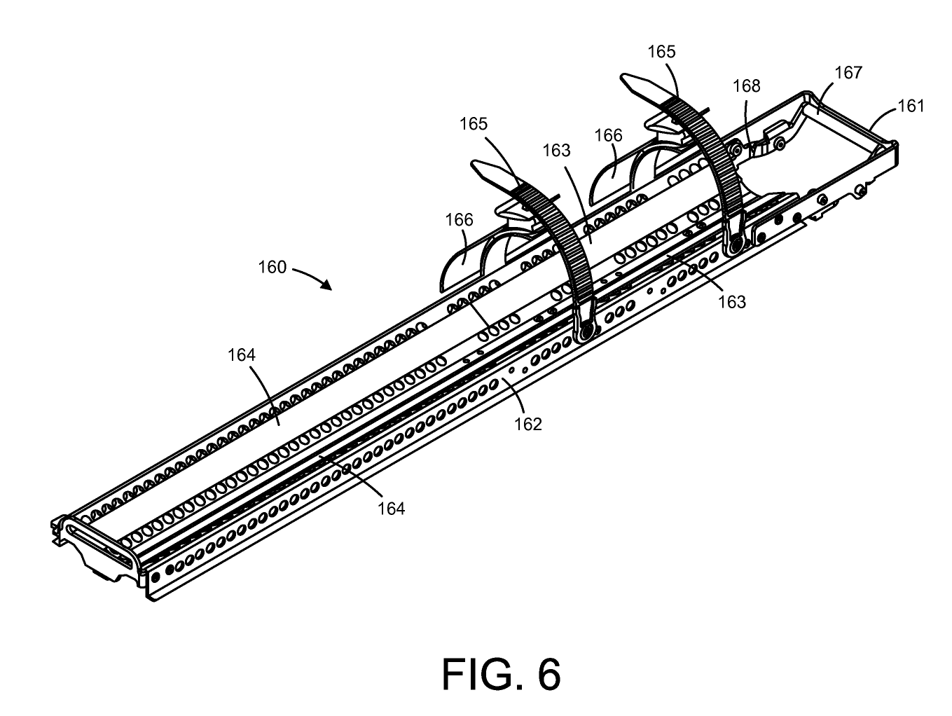

FIG. 6 is a view of a single slide-out internal compressed gas cylinder storage tray 160. The slide-out internal compressed gas cylinder storage tray 160 can be made of a light-weight, yet strong metal alloy, such as an aluminum or titanium alloy. Alternatively, the slide-out internal compressed gas cylinder storage tray 160 can be made out of a high strength to weight ratio polymer composite or ceramic material, such as a graphite or aramid fiber reinforced polymer, a suitably tough ceramic, or a metal-ceramic composite. Fiber reinforced polymer composites can include those in which the fibers include glass, graphite, or aramid fiber. The portion of the tray in which a cylinder of compressed gas sits 162 can be made with a plurality of holes or openings to reduce the weight of the structure without sacrificing the strength of the tray. The portion of the slide-out internal compressed gas cylinder storage tray 160 which is affixed to the frame 140, and on which the sliding portion 162 sits, is part 169. This part can include rails of low weight, high strength, and low friction material. Such material can include polymers such as polyacetal polymers, including poly formaldehyde, acetal homopolymer, and polyoxymethylene (POM), which is also known as Delrin®. FIG. 6 also shows various holes in the tray bed 162 which can be used to anchor the straps 165 that hold a cylinder in place. These holes allow the tray 160 to accommodate cylinders with various lengths and pressure regulator configurations.

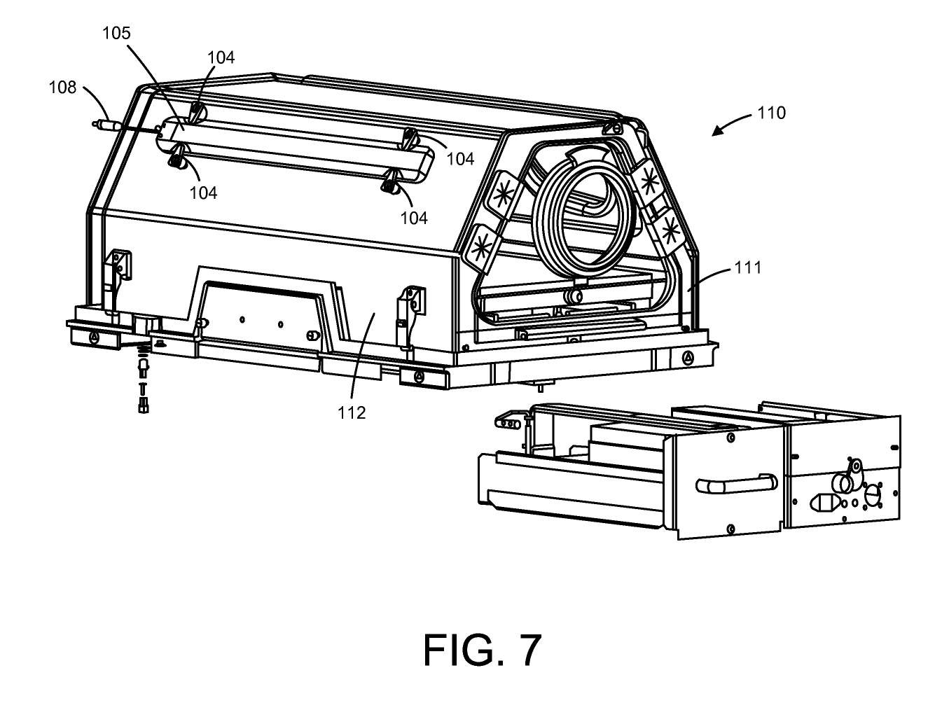

FIG. 7 illustrates a neonatal transport incubator 110 with a head-end access panel 111, a slide out mattress tray 112, and an examination light 105. The incubator 110 can have improved temperature control as compared to other incubators due to superior insulation qualities. Such insulative qualities can be the result of the materials used to construct the incubator 110 or of the construction of the incubator 110. For example, the incubator 110 can be double walled. The incubator can also have integrated humidity control features, as well as power supply flexibility that allows it to draw current from one or more batteries, a wall socket, or a vehicle power supply. The incubator 110 can be equipped with features that reduce the power draw of the unit while allowing a care giver to adequately monitor the health of an infant or neonatal patient in transit. An example of such a device is the examination light 105. The examination light 105 includes light emitting diodes (LEDs) as the light source. LEDs are bright and require less power than incandescent lights. Additionally, the LED examination light is low-profile, allowing the incubator 110 to be easily inserted into and extracted from tight spaces inside various types of transport vehicles. The examination light 105 shown is also easily removable and interchangeable. Spring loaded clips 104 can retain the examination light 105 on the incubator 110. The clips 104 can be moved by depressing and rotating each clip. Once removed, the examination light 105 can be moved to a location where light is needed that is away from the incubator 110 or it can be replaced, such as in the case of a malfunctioning light. The power plug 108 can connect the examination light 105 to a power source on the incubator 110, on the system 100, or even a power source external to the transport incubator system 100.

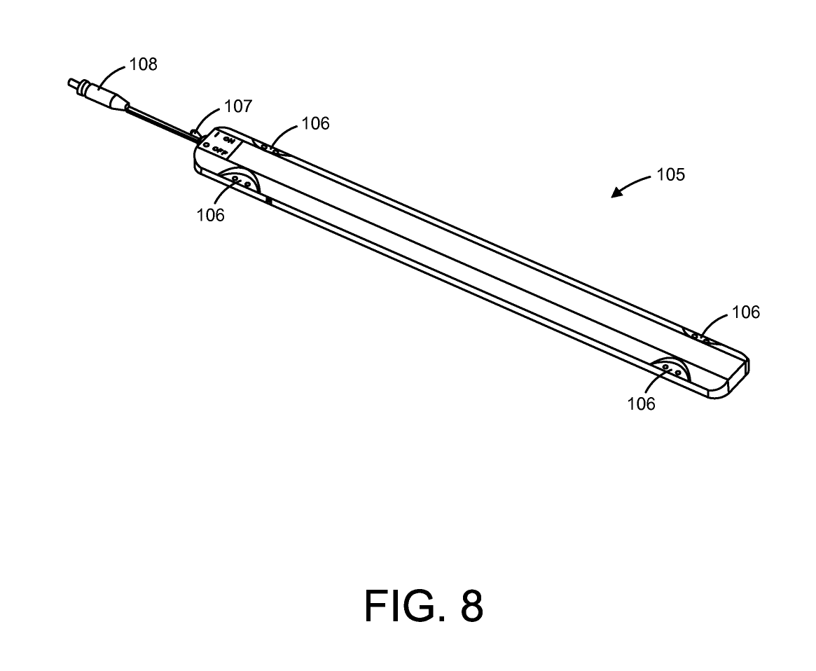

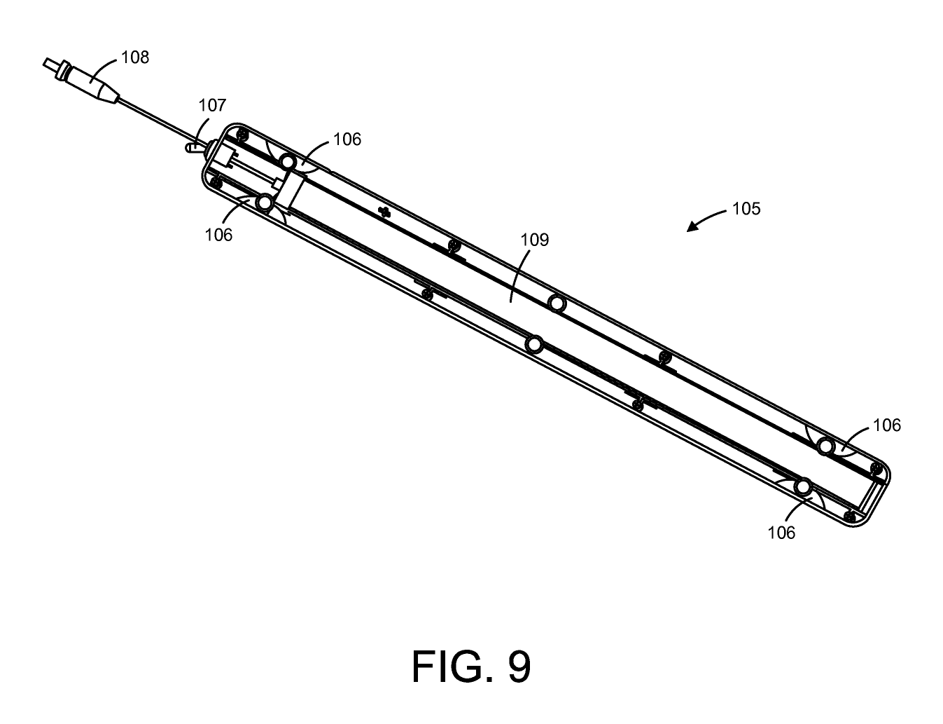

FIGS. 8 and 9 are more detailed views of the examination light 105. Recesses 106 on the top portion of the examination light 105 receive the clips (104 in FIG. 7). The power switch 107 allows a user to power off the examination light 105 without turning off other components of the transport incubator system 100. The LEDs 109 can be covered by a diffusive material or a filtering material, to adjust light intensity if desired. When alteration or selection of the wavelength of light dosing the patient is desired, an alternate examination light 105 with LEDs that emit at a different wavelength, for example ultra-violet light, can be used. An examination light 105 with different types of LEDs that emit at distinct wavelengths which can be selectively switched on and off can also be used in situations where various wavelengths of light are desired for dosing the patient.

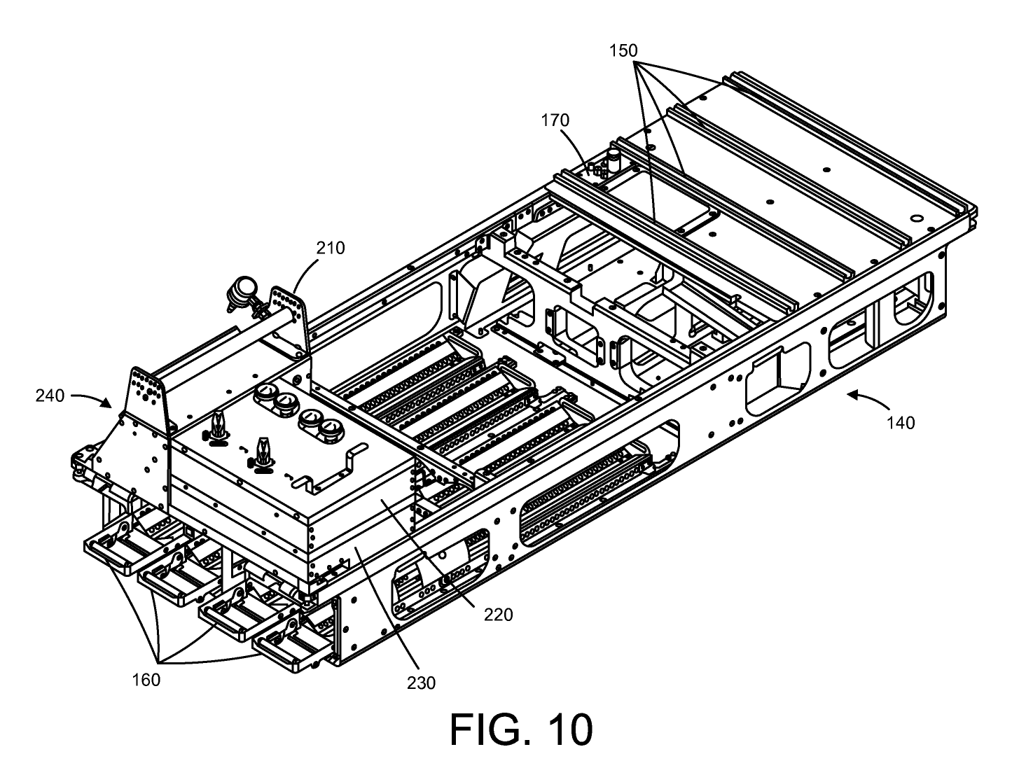

FIG. 10 illustrates a transport incubator system frame 140 with an accessory deck 145, slide-out internal compressed gas cylinder storage trays 160, a monitor mount 210, a pneumatic control box 220, an electrical control box 230, and a ventilator 240. On the accessory deck 145 are T-slot rails 150 onto which a ventilator connection plate 170 sits, adjacent to where the head-end of the incubator is normally located.

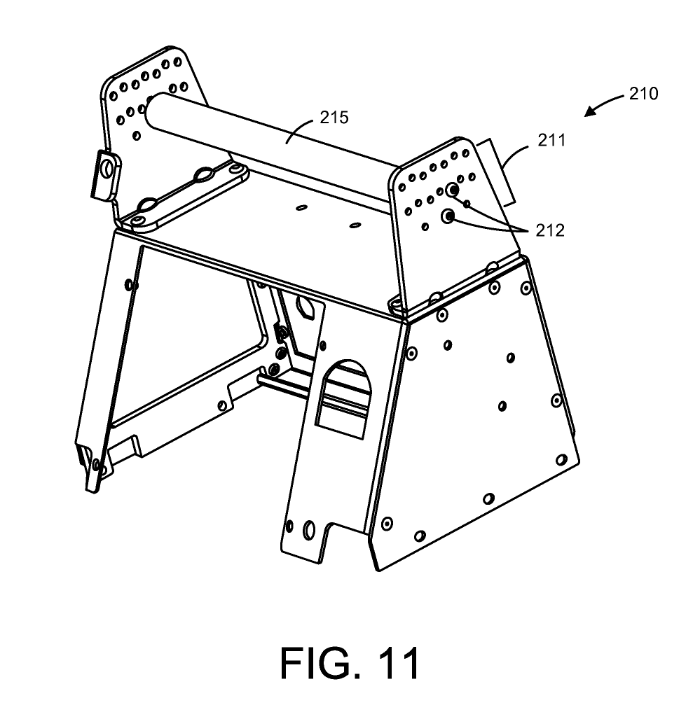

The monitor mount 210 is shown in greater detail in FIG. 11. The monitor mount 210 can be configured to fit over a ventilator (not shown in FIG. 11). A patient monitor 120 attaches to a bar 215 in the course of normal use of the system 100. The patient monitor 120 can be used to display the vital signs of the patient and alert a care giver of dangerous situations. Each type of patient monitor 120 can require a different location of the bar 215 relative to the rest of the mount. As such, a grid of fitting holes 211 is available to accommodate the position required. Fittings 212, such as screws, secure the bar 215 into place. The monitor mount 210 and its fittings are crash tested and vibration tested to meet or exceed the industrial or regulatory requirements of the locations in which these systems can be used.

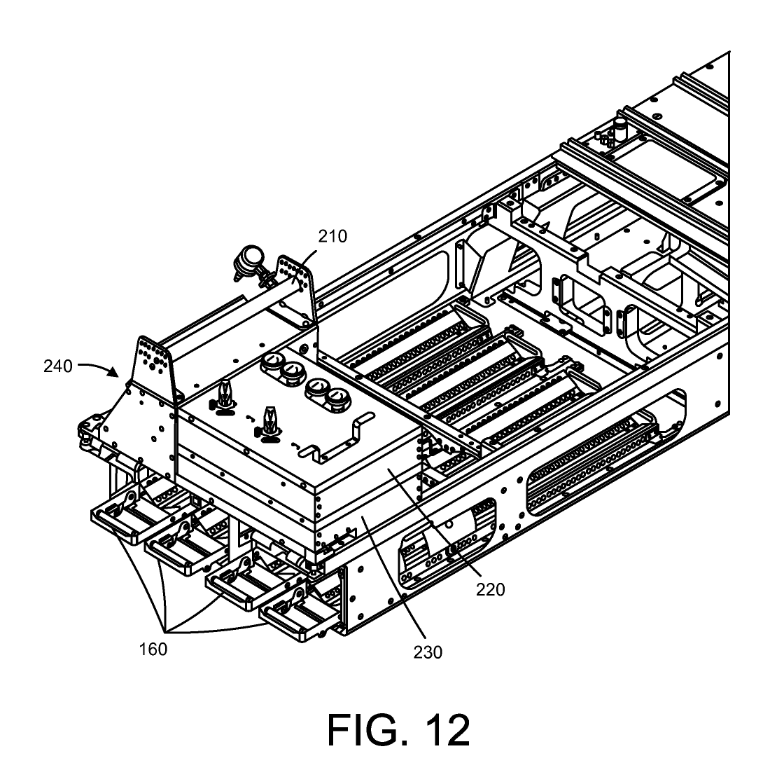

FIG. 12 shows the relative locations of the monitor mount 210, ventilator 240, pneumatic control box 220, electrical control box 230, and slide-out internal compressed gas cylinder storage trays 160 in the transport incubator system frame 140. The pneumatic control box 220 and electrical control box 230 maintain separate enclosures for electrical and pressurized gas components. Though the bottom of the pneumatic control box 220 forms the lid or cover of the electrical control box 230, the physical barrier provided by the lid is sufficient to prevent a hazardous collection of flammable gas in the electrical control box 230. A gasket helps to ensure that the environment within the electrical control box 230 is less than 25% oxygen enriched. An alarm can be present in the electrical control box 230 to indicate when the environment within the box becomes oxygen enriched to a concerning level, such as 15%, 20%, or 25% oxygen enriched. A concerning level of oxygen in the electrical control box 230 can be 25% or greater oxygen enriched. In general, the electrical control box 230 can include a physical barrier sufficient to prevent oxygen accumulating above a concerning level, such as 25% or greater oxygen enriched.

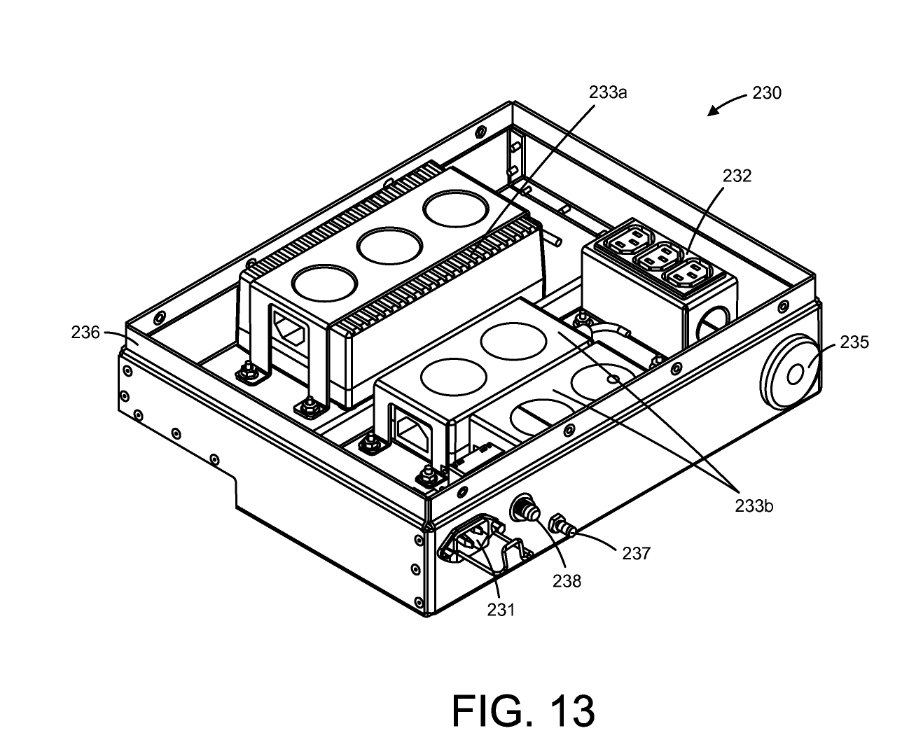

FIG. 13 illustrates the contents of the electrical control box 230. As indicated above, the pneumatic control box 220 fits above the electrical control box 230. The shape of the tops of the walls of the box, indicated by 236, facilitates this configuration. The components of the electrical control box 230 include a power inlet 231, an AC distribution box or strip 232, AC to DC converters 233a and 233b, and an outlet 235. Located near the outlet 235 on the outside of the box are an equipotential stud, or ground, 237 and a surge protection component 238. The AC to DC converters 233a and 233b can be manufacturer supplied components that correspond to parts of the system such as the ventilator, monitor, and the like.

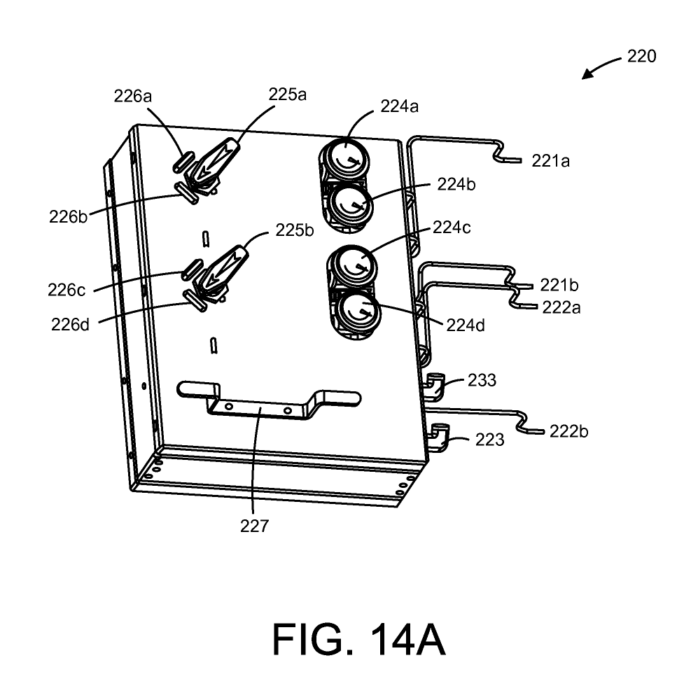

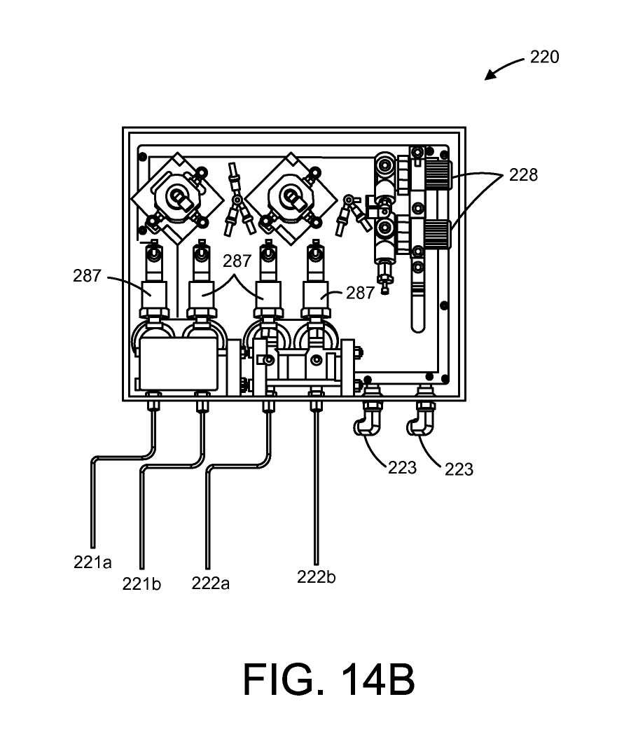

FIG. 14a illustrates the outside of a pneumatic control box 220. The pneumatic control box 220 houses regulators and possibly pressure transducers for compressed gases feeding into the transport incubator system from gas cylinders or other sources. The components shown in FIG. 14a include regulator gauges 224a-d, lines 221a and 221b transferring gas 1 in from cylinders, lines 222a and 222b transferring gas 2 in from cylinders, inlets for wall sources of gas 223, knob 225a to 4-way ball valve for directing the source of gas 1 to the system, knob 225b to 4-way ball valve for directing the source of gas 2 to the system, reed switches 226a-d for displaying data from pressure transducers or other sensors on a monitor or other screen, and a cord storage bracket 227. The possible configurations and workings of the valves for selecting the source of each gas, their associated knobs 225a and b, and the display buttons (i.e. reed switches) 226a-d are described in greater detail in International Patent Application serial no. PCT/US11/51052 filed on Sep. 9, 2011, titled, “Electronic Valve Position Indicator,” the contents of which are incorporated by reference herein in its entirety.

FIG. 14b shows many of the same components of FIG. 14a, but also allows for a view of transducers 287 and regulators for wall sources of gas 228. The pneumatic control box 220 can include at least one physical barrier to prevent a hazardous collection of a flammable gas, such as oxygen, outside of the box. As mentioned above, a physical barrier can be a gasket or a wall, or a combination thereof.

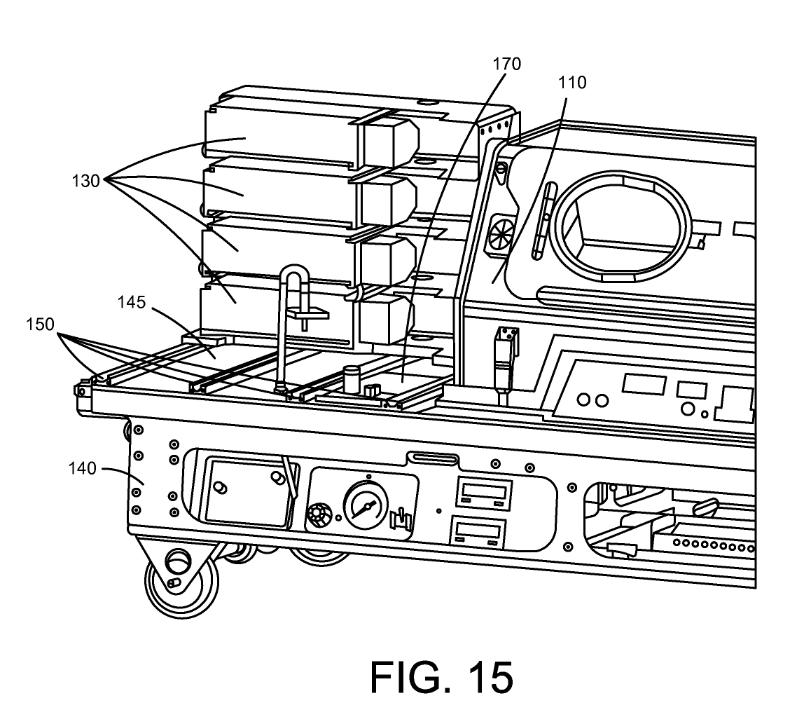

Seen in FIG. 15 are: a transport incubator system frame 140 with T-slot rails 150 on an accessory deck, infusion pumps 130 that mount onto the frame via the T-slot rails 150, an incubator 110 with its head-end adjacent to the accessory deck, and a ventilator connector plate 170 mounted on the accessory deck.

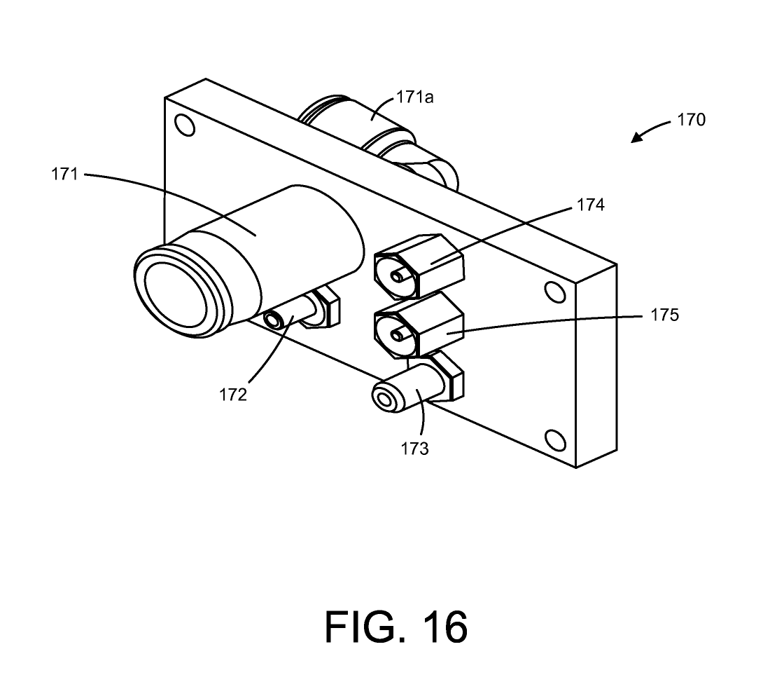

FIG. 16 illustrates a ventilator connector plate 170 that is mounted on the accessory deck 145 and that connects to the patient and to a ventilator 240. The fittings that attach to lines that lead to the patient that are shown include an inhalation or inlet fitting 171, an exhalation or expiratory fitting 172, a patient airway fitting 173, and a distal connector 174 and a proximal connector 175 that are used to make flow rate determinations. Not all fittings can or need to be used with every ventilator. For example, some ventilators may not use the flow rate fittings 174 and 175.

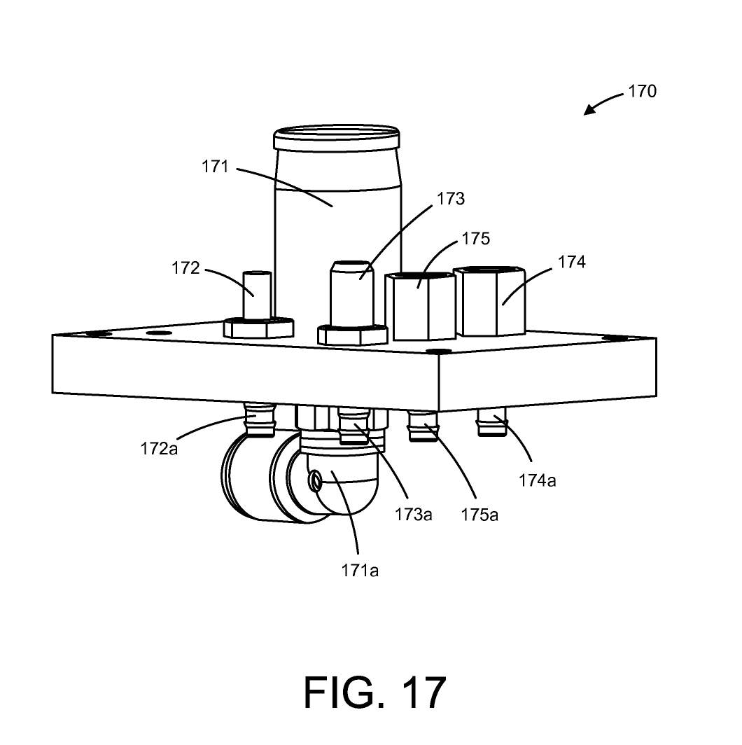

FIG. 17 is an alternate view of the ventilator connector plate 170 that also shows the fittings that lead back to the ventilator 240. The fittings include the patient inhalation fitting 171a; the fitting to the exhalation line 172a; and the fitting to the patient's airway 173a. Fittings 174a and 175a can lead back to the ventilator 240 if the ventilator is configured to measure or utilize flow rate readings.

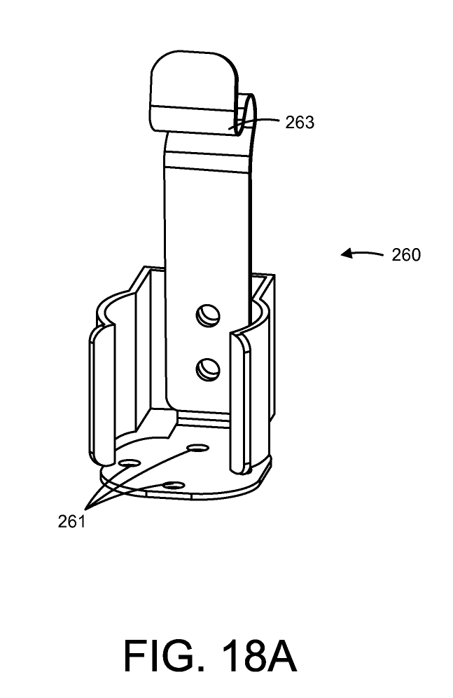

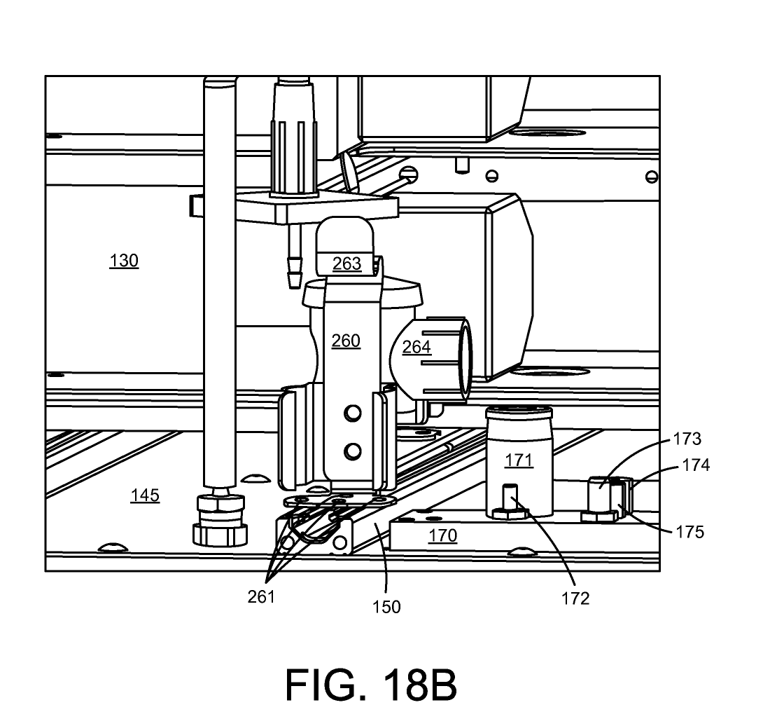

FIGS. 18a and 18b show different views of a clip mounting for a suction collector 260. The suction collector that can be used with this system has a volume on the order of 40 ml (or 40 cc). Additionally, the clip mounting 260 can be secured to the frame 140 via the T-slot rails 150 by utilizing the holes 261 located on the bottom of the mount 260. A retaining clip 263 is located above the holes 261 and serves to help keep the suction collector container in place. FIG. 18b shows a clip mounting for a suction collector 260 with an exhalation valve 264 on the accessory deck 145 on a T-slot rail 150. It is located adjacent to a ventilator connection plate 170 and infusion pumps 130.

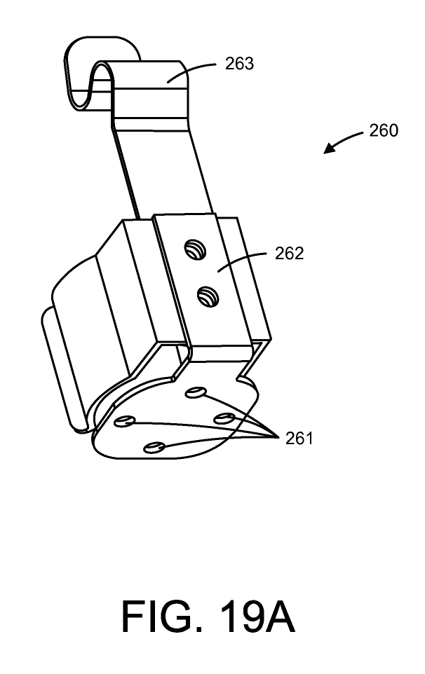

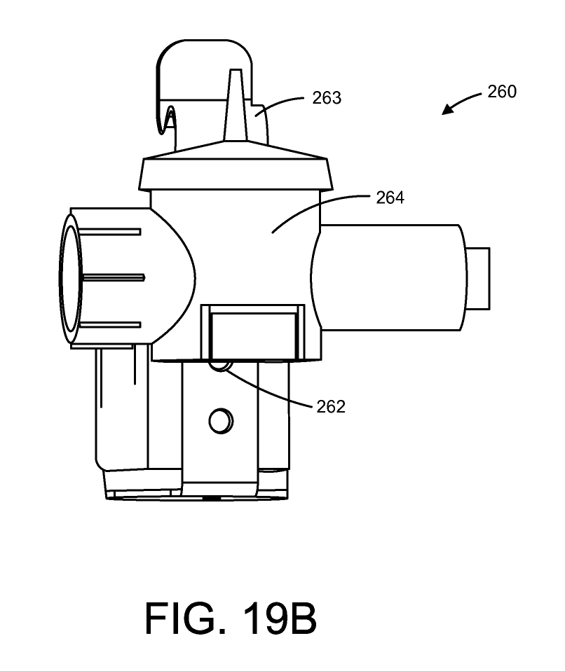

FIGS. 19a and 19b illustrate another view of a clip mounting for a suction collector 260 in which the mounting site 262 for the exhalation valve 264 can be seen.

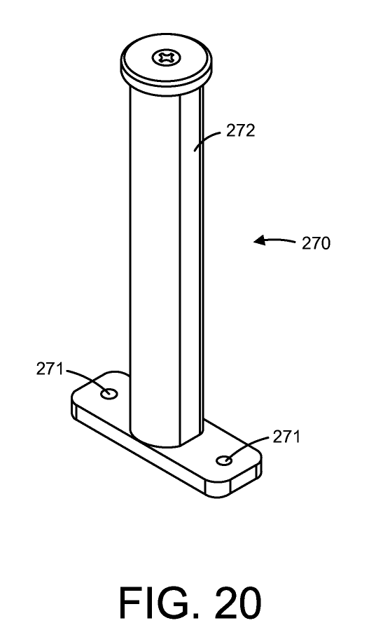

An accessory pole 270 that is mounted onto the accessory deck 145 via the T-slot rails 150 is shown in FIG. 20. Fittings, such as nuts, can be inserted into the holes 271 on the base of the pole component 270 to attach it to the T-slot rails 150. The pole itself 272 can be used to support one or more infusion pumps, an oxygen monitor, or other equipment.

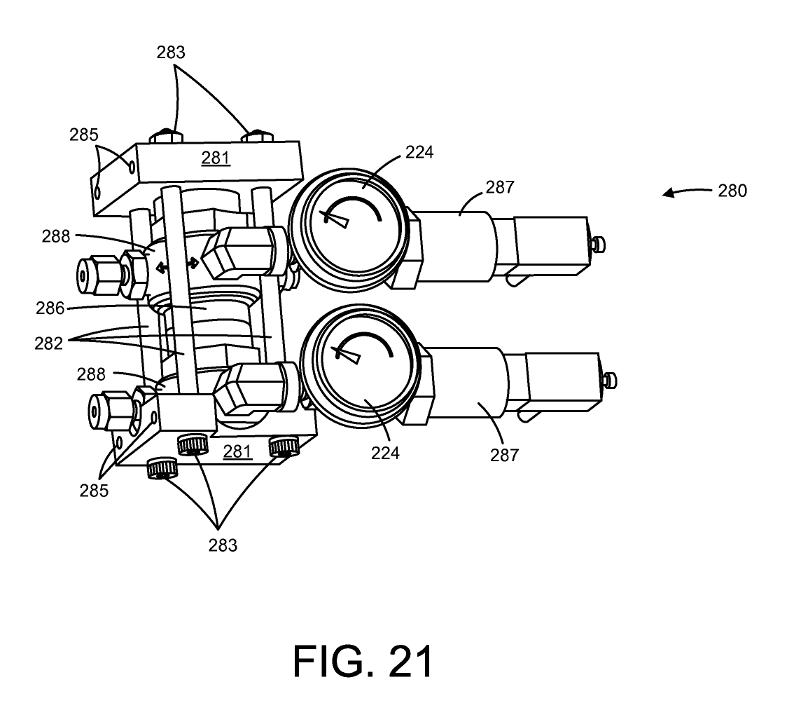

FIG. 21 illustrates an implementation of a regulator mount 280, such as can be found within the pneumatic control box 220. The regulator mount 280 includes end blocks 281, fittings in the blocks 285 for mounting the regulator mount 280 into the pneumatic control box 220, rods 282, fittings to attach the rods 282 to the end blocks 281, and one or more silicone damper discs 286. The end blocks 281 can be made of any suitable light-weight yet strong material, including aluminum and aluminum alloys. Also shown in FIG.21 are two pressure regulators 288 within the regulator mount 280. The silicone damper disc 286 serves to isolate the pressure regulators 288 from each other, for example with respect to vibrations. The damper disc 286 can be made of another suitable material other than silicone, such as natural rubber, latex, and the like. FIG. 21 shows pressure transducers 287 attached to the pressure regulators 288. As described herein above, the pressure transducers 287 can be used to indicate the status of a source of a compressed gas.

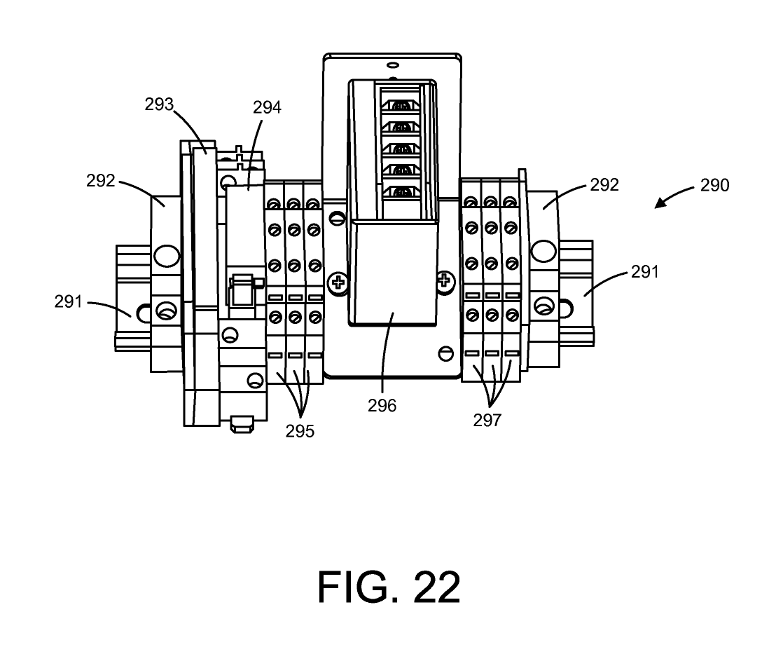

The DC distribution component 290 is shown in FIG. 22. The distribution component 290 is an assembly of components on one or more DIN rails. The assembly is bookended by end brackets 292. Shown also are a fuse holder 293, a 6 VDC relay 294, two-level terminal blocks which are switched v. battery bus 295, a DC to DC converter 296, and two-level terminal blocks that are a DC to DC output bus 297. The DC distribution component 290 is a way for a user to shut down the transport incubator system 100 completely without accidentally leaving a battery draining component switched on.

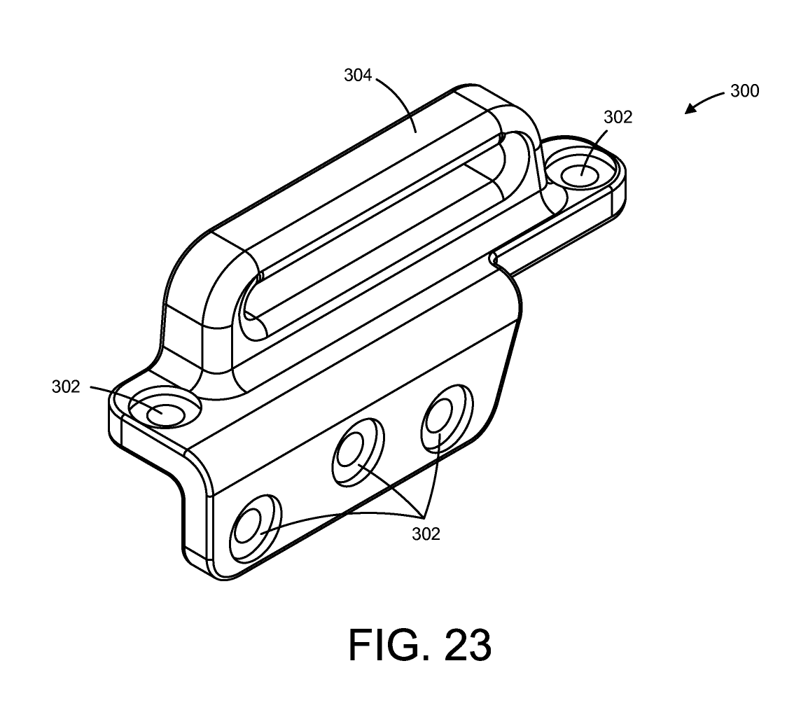

FIG. 23 illustrates a strapping point or tie down component 300 that allows for temporary or reinforcing connections between the transport incubator system 100 and a sled or trolley. The strapping point component 300 attaches onto the system frame 140 through fixture points 302. The areas on the system frame 140 where the strapping component 300 can attach are those which avoid blocking any instrumentation panels when straps are fitted through the strap fitting 304. These strapping points 300 can be located on a transport incubator system frame 140 so as to keep clear of joints and instrumentation on both the sleds or trolleys on which the incubator systems are placed and the incubator systems themselves. Selection of locations for the strapping points 300 can involve vibration analysis, such as a computer model of behavior of the system frame with various hypothetical strapping points in different modes of vibration on various types of sleds or trolleys. Such vibrational analysis can be used in conjunction with knowledge of the functioning of a specific sled or trolley to be used. Strapping point locations can be selected based upon the optimization of the vibrational analysis and lack of impedance to the performance of the sled or trolley. Additionally, the strapping point locations can be selected based upon optimization of the vibrational analysis and upon knowledge of multiple types of sleds or trolleys, especially sleds or trolleys commonly used in a geographic location or type of vehicle.

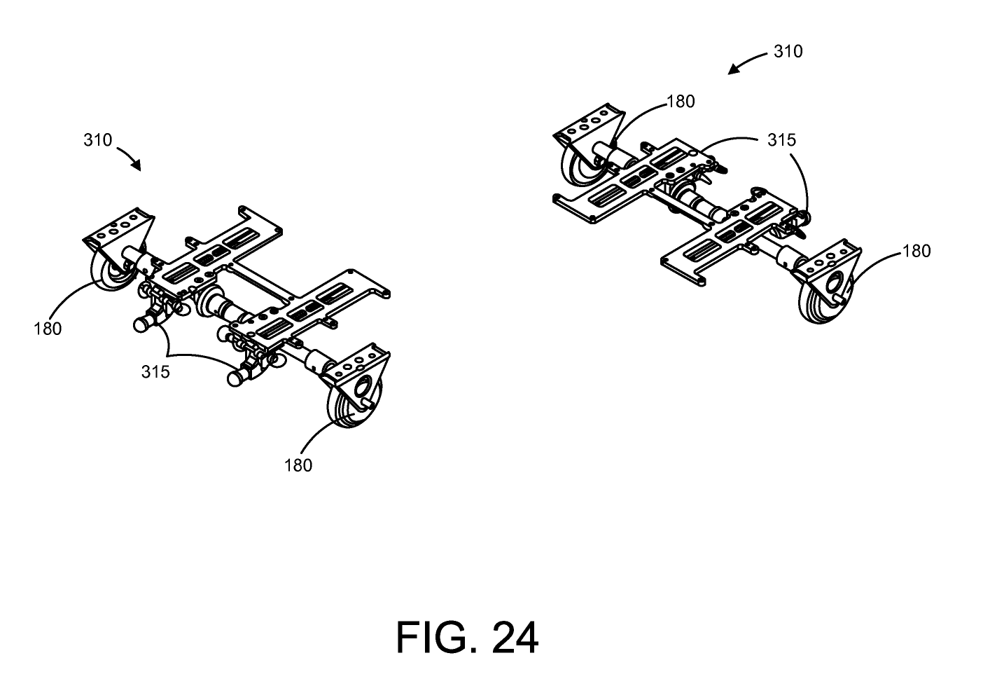

FIG. 24 illustrates a wheel assembly 310 for a transport incubator system 100. The wheel assembly 310 includes wheels 180 and aircraft, or vehicle, fittings 315. The types of fittings that can be used as air craft fittings 315 can include any fittings that meet or exceed the requirements of the transportation and/or safety agencies where the transport incubator system 100 will be used. An example of such a fitting is a Bucher pin which can attach into specific points in an aircraft's, or other vehicle's, floor.

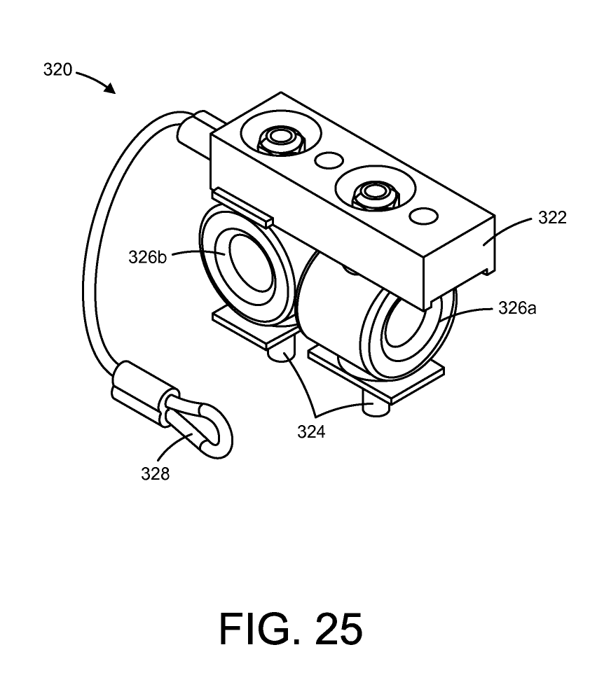

FIG. 25 illustrates a dampening system 320 for a transport incubator system 100. The dampening system 320 can be located between the bottom portion of the incubator and the top portion of the transport incubator frame 140. The dampening system 320 can include a mount to the incubator 322, one or more frame mounts 324 that attach to the transport incubator frame 140, dampers 326a and 326b, and a tether 328 that restricts the movement of the incubator relative to the transport incubator frame 140. For example, the tether 328 can limit the range of motion of the incubator away from the transport incubator frame 140 in the event that the transport incubator system 100 is upended or the dampers 326 are stretched beyond their limits. The dampers 326a and 326b shown are cylindrical in shape, and the axes which pass through the center of each damper are orthogonal to each other. This orientation, coupled with the deformable nature of each damper, allows the incubator to be isolated from much of the vibration that could be passed from the transport vehicle and through the frame 140. The deformable nature of each damper can include deformable material, a deformable shape, or both deformable material and a deformable shape. The dampers may be cylindrical, or prism shaped, such as triangular, elliptical, square, or rectangular in cross-section. The dampers may be hollow or solid. The dampers may be made of a dense, solid material; of a foamed material; of a material that is partially a foamed material and partially a dense, solid material; the dampers may be made of a perforated material; or any combination thereof. In the case of prism shaped dampers, the axes which are orthogonal to each other are the axes which are parallel to the length of each prism shaped damper. The dampening system 320 can include two or more dampers 326, and at least two of the dampers 326 will have their corresponding axes orthogonal to each other.

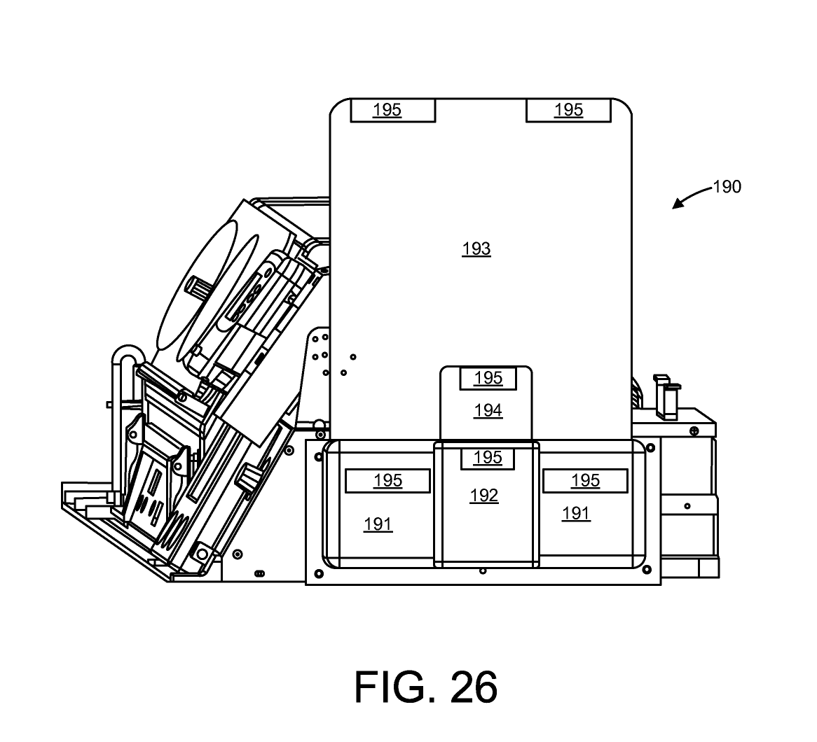

FIG. 26 illustrates a patient chart and hand-held device holding compartment 190. The compartment 190 has a larger pocket 191 that can hold a patient chart. The larger pocket 191 also has a chart cover 193 that can be folded down to hold a chart while the incubator system is in transit. Loop-and-hook closures, such as Velcro®, 195 can ensure that the chart cover 193 stays in place even in windy or otherwise rough conditions. The compartment 190 can also have a smaller pocket 192 that can hold a hand-held device in transit. This smaller pocket 192 can have a cover 194 that is fastened closed with loop-and-hook closures 195 as well. Additionally, the hand-held device can be seen while in transit due to mesh material of the cover 194 and pocket 192.

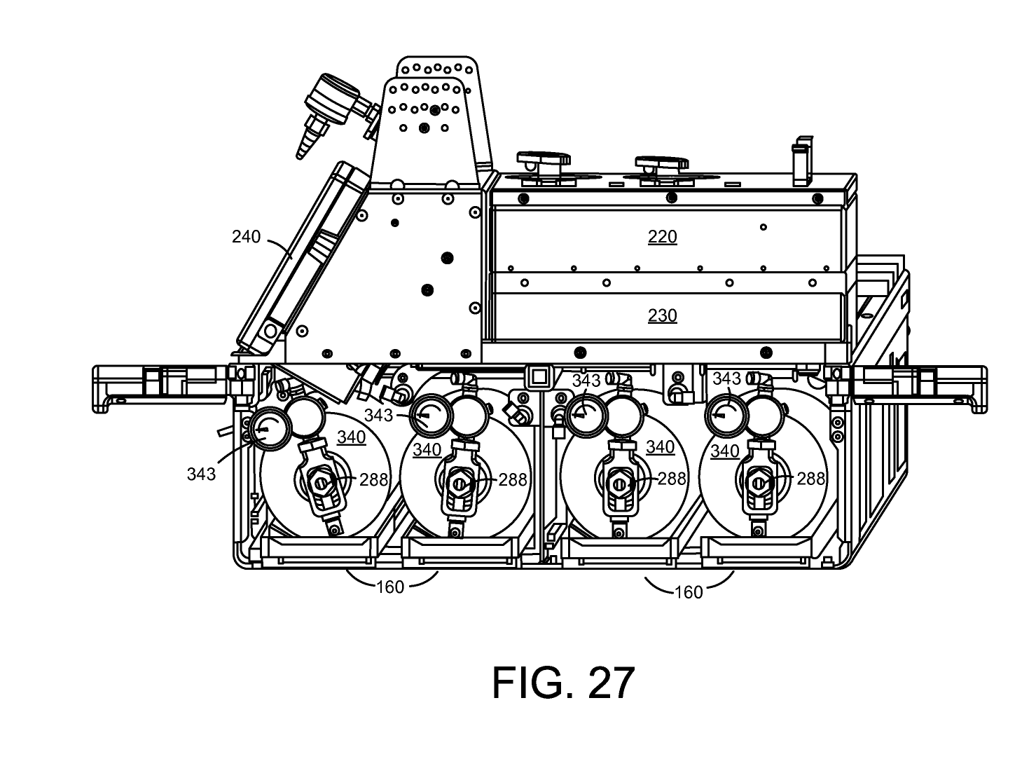

FIG. 27 illustrates a transport incubator system configuration in which flow regulators 288 are mounted on the compressed gas cylinders 340, as opposed to in a pneumatic control box 220. Due to the size and motion requirements of the slide-out internal compressed gas cylinder storage trays 160, the gas flow regulator assemblies can have very particular orientations of components, gas lines, and electrical cables. Examples of such particular requirements and orientations include using push-to-connect fittings, such as Quick Connect fittings, for the low pressure (i.e. pressure about 50 PSI or less) pneumatic output from the regulators 288 on the cylinders 340; using electrical connectors for the pressure transducers to relay the signal to an electronic display; having the same orientation for all connections; making all of the gas lines the same length; adjusting the length of country specific fittings so that they are all of one length; and modifying the transducers and regulator gauges 343 to be lower-profile above the cylinders 340 to accommodate the clearance between gas cylinders and the frame 140. Other possible accommodations to facilitate having pressure regulators mounted on compressed gas cylinders in transport incubator systems with slide-out trays 160 include changing the locations of electrical and pneumatic connections, moving outboard connection locations, utilizing higher quality and better secured electrical connectors, including strain relief mechanisms, and protecting low-pressure lines from mechanical damage. Protecting low-pressure lines can encompass either routing a line through an area where abrasion will not be an issue or physically protecting or encasing vulnerable lines. A transport incubator system configuration in which flow regulators 288 are mounted on the compressed gas cylinders 340 can have none, some, or all of the modifications to orientation and equipment listed herein.

The transport incubator systems described herein can be used in transporting infants or neonatal patients from one location to another via ground ambulance, medevac HEMS helicopter, or fixed-wing aircraft. The incubator system can maintain the required atmosphere by employing various powered and/or passive systems. Powered systems can be battery powered or can utilize electricity from the vehicle in which the transport incubator system is located. Multiple cylinders of one or more compressed gases can be carried on the transport incubator system to provide oxygen, air, or other gas mixtures to a patient. Alternatively, a powered air compressor can provide breathing gases to a patient. A powered active humidification system can also deliver heated, humidified air or other blend of gas to the interior of the incubator, or alternately, a passive humidity system that can include pads that maintain a humidity level within the incubator can be used. The passive humidity system can be used in place of the active humidification system when battery power levels require it, or the passive humidity system can be used in conjunction with the active humidity system to reduce the overall power draw. A battery in new, fully charged condition for use with the transport incubator systems described herein can operate the system for a minimum of about 45 minutes. Two or more such batteries can be used in parallel to increase transport time, such as to about 80 minutes or more, or even about 90 minutes or more. Alternatively, one such battery can be providing power while a second is charging, drawing current from the vehicle transporting the system. Additionally, three or more batteries can be used together so that two or more are providing power in parallel while others are being charged by the vehicle. As noted above, the incubator and the overall transport incubator system can be designed to minimize weight while maintaining strength, as well as to optimize power usage with features such as light-weight frame and tray features, insulative walls on the incubator, and accessories that require little power.

The transport incubator systems can also be used in a hospital or other fixed locations, as they can be compatible with wall sources of gases, such as air and oxygen, and can be compatible with fixed sources of power, such as a wall outlet. Monitors used in hospitals and other care-giving locations can also be used with the transport incubator systems described herein. The lights of the transport incubator systems described herein can include white light LED lights, as well as those which provide other wavelengths of light, to treat infants for various ailments, including jaundice.

Various aspects of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, the memory, at least one input device, and at least one output device such as a display.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The implementations set forth in the foregoing description do not represent all implementations consistent with the subject matter described herein. Instead, they are merely some examples consistent with aspects related to the described subject matter. Wherever possible, the same reference numbers will be used throughout the drawings to refer to the same or like parts.

Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows and steps for use described herein do not require the particular order shown, or sequential order, to achieve desirable results. Similarly, elements located on the front, back, side, top, or bottom of an embodiment or implementation are to be understood as relatively positioned, unless otherwise specified. Other embodiments can be within the scope of the claims.

What is claimed is:

1. A transport system for maintaining a pediatric or neonatal individual in a controlled environment comprising:
a system frame configured to couple and decouple to the bottom portion of an incubator at a top portion of the system frame, the system frame further comprising a bottom portion configured to accommodate one or more components that provide operational support to the system; and
at least one slide-out internal compressed gas cylinder storage trays operably attached to the system frame.

2. The system of claim 1, wherein the at least one slide-out internal compressed gas cylinder storage trays are located beneath the portion of the system frame that couples to the bottom portion of an incubator.

3. The system of claim 1, wherein each of the at least one slide-out internal compressed gas cylinder storage trays comprises:
a tray handle; and
an actuating, locking handle.

4. The system of claim 3, wherein each one of the at least one slide-out internal compressed gas cylinder storage trays has a latch that is released with movement of the actuating, locking handle, wherein releasing the latch allows each tray to slide out.

5. The system of claim 1, wherein each of the at least one slide-out internal compressed gas cylinder storage trays has straps for securing a compressed gas cylinder.

6. The system of claim 1, wherein each of the at least one slide-out internal compressed gas cylinder storage trays is lined with a high-friction material and a material with a low coefficient of friction.

7. The system of claim 6, wherein the high-friction material is located along an underside portion of each strap.

8. The system of claim 6, wherein the material with a low coefficient of friction covers a portion of each tray that is furthest away from the tray handle and reduces a force a user needs to apply while sliding a gas cylinder into place.

9. The system of claim 1, wherein each of the at least one slide-out internal compressed gas cylinder storage trays sits on rails of low weight, high strength, and low friction material.

10. The system of claim 9, wherein the rails comprise polyacetal polymers.

11. The system of claim 1, wherein each of the at least one slide-out internal compressed gas cylinder storage trays comprises a plurality of holes configured to accept straps at different locations to accommodate different sized cylinders.

12. The system of claim 1, wherein each of the at least one slide-out internal compressed gas cylinder storage trays comprises a plurality of holes configured to lighten the weight of each tray.

13. The system of claim 1, wherein each of the at least one slide-out internal compressed gas cylinder storage trays comprises a plurality of holes configured to accommodate straps for different sized cylinders and to lighten the weight of each tray.

14. The system of claim 1, wherein the at least one slide-out internal compressed cylinder storage trays comprise a light-weight and strong metal alloy.

15. The system of claim 1, wherein the at least one slide-out internal compressed cylinder storage trays comprise a high strength to weight ratio polymer composite.

16. The system of claim 1, wherein the at least one slide-out internal compressed cylinder storage trays comprise a ceramic material.

17. The system of claim 1, further comprising an incubator comprising a top portion and a bottom portion, the bottom portion of the incubator removably connected to the top portion of the system frame.
